(19) United States
(12) Patent Application Publication
(10) Pub. No.: US 2016/0202945 A1
(43) Pub. Date: Jul. 14, 2016

(54) APPARATUS AND METHOD FOR CONTROLLING MULTIPLE DISPLAY DEVICES BASED ON SPACE INFORMATION THEREOF

(71) Applicant: Electronics and Telecommunications Research Institute, Daejeon-si (KR)

(72) Inventors: Il Hong Shin, Daejeon-si (KR); Eun Jun Rhee, Daejeon-si (KR); Dong Hoon Kim, Yongin-si Gyeonggi-do (KR); Hyun Woo Lee, Seoul (KR)

(21) Appl. No.: 14/994,740

(22) Filed: Jan. 13, 2016

(30) Foreign Application Priority Data
Jan. 14, 2015 (KR) 10-2015-0007009

(51) Int. Cl. G06F 3/14; G09G 5/38

(52) U.S. Cl. CPC G06F 3/1446; G09G 5/38

(57) ABSTRACT

An apparatus and method for controlling multiple display devices based on space information thereof. The apparatus includes a receiver configured to receive space information of multiple display devices; a controller configured to generate a virtual space and generates a scene by mapping content to a screen of each of the multiple display devices in the virtual space based on the space information; and a transmitter configured to transmit information on the generated scene to each of the multiple display devices.

### CROSS-REFERENCE TO RELATED APPLICATION(S)

This application claims priority from Korean Patent Application No. 10-2015-0007009, filed on Jan. 14, 2015, in the Korean Intellectual Property Office, the entire disclosure of which is incorporated herein by reference for all purposes.

### BACKGROUND

1. Field

The following description relates to an image processing technology and, more particularly, to a technology of controlling and managing multiple display devices.

2. Description of the Related Art

Multiple display devices are used for exhibition or artistic expression. Recently, it is widely used, for example, as a digital signage or a digital bulletin board installed in a public place, and considered an effective substitute for a large-sized display.

However, it is hard to install and repair multiple display devices and control each of them. In addition, each display needs to receive an individual input in a wired manner. Furthermore, an expensive conversion system, such as a converter or a multi-GPU, is required. In general, content is divided in two dimension (2D) and then displayed separately in display devices. However, for special visual effects, content made for the exclusive use for it is required.

### SUMMARY

In one general aspect, there is provided a multi-display controlling apparatus including: a receiver configured to receive space information of multiple display devices; a controller configured to generate a virtual space and generates a scene by mapping content to a screen of each of the multiple display devices in the virtual space based on the space information; and a transmitter configured to transmit information on the generated scene to each of the multiple display devices.

The space information may include location information, size information, and rotation information of each of the multiple display devices. The content may be three-dimensional (3D) content to be displayed in a virtual space.

The receiver may receive the space information of each of the multiple display devices from a sensor.

The controller may map the content to a screen of each of the multiple display devices based on real-time space information of each of the multiple display devices that are dynamically changed.

The controller may include: a space generator configured to generate the virtual space, arrange the content in the virtual space, and determine a location and angle of each of the multiple display devices based on the space information; a renderer configured to generate the scene by mapping the content to a screen of each of the multiple display devices based on the determined location and angle, and render the scene; and an extractor configured to extract a rendering result that is mapped to a screen of each of the multiple display devices.

The renderer may arrange cameras at locations of the multiple display devices based on the space information and map content displayed on a screen of each of the multiple display devices into a real physical space. At this point, the renderer may enlarges or reduces the content displayed on a screen of a corresponding display device. The renderer may rotate a specific camera based on rotation information of a corresponding display devices in order to offset rotation of a screen of the corresponding display device.

The transmitter may transmit the content to each of the multiple display devices over a wired or wireless network. The transmitter may transmit image information through a communication device included in each of the multiple display devices. The transmitter may compress image information and transmit the compressed image information to each of the multiple display devices.

In another general aspect, there is provided a multi-display controlling method including: receiving space information of multiple display devices; generating a virtual space and generating a scene by mapping content to a screen of each of the multiple display devices in the virtual space based on the space information; and transmitting information on the scene to each of the multiple display devices. The space information may include location information, size information, and rotation information of each of the multiple display devices.

The generating of a scene may include generating the scene by mapping the content to each of the multiple display devices based on real-time space information of each of the multiple display devices that are changed dynamically.

The generating of a scene may include: generating the virtual space, arranging the content in the virtual space, and determining a location and angle of each of the multiple display devices based on the space information; generating a scene by mapping the content to a screen of each of the multiple display devices based on the determined location and angle, and rendering the scene; and extracting a rendering result mapped to the screen of each of the multiple display devices.

The rendering of a scene may include arranging cameras at locations of the multiple display devices based on the space information and mapping content displayed on a screen of each of the display devices into a real physical space.

The rendering of the scene may include arranging the cameras based on location information of each of the multiple display devices and enlarging or reducing the content displayed on a screen of a corresponding screen.

The rendering of the scene may include rotating a specific camera based on location information of a corresponding display device to offset rotation of a screen of the corresponding display device.

Other features and aspects may be apparent from the following detailed description, the drawings, and the claims.

### BRIEF DESCRIPTION OF THE DRAWINGS

FIG. 1 is a diagram illustrating a configuration of a multi-display system according to an exemplary embodiment of the present disclosure.

FIG. 2 is a diagram illustrating a multi-display controlling apparatus shown in FIG. 1, according to an exemplary embodiment of the present disclosure.

FIG. 3 is a diagram illustrating a controller shown in FIG. 3 according to an exemplary embodiment of the present disclosure.

FIG. 4 is a conceptual diagram illustrating a virtual space according to an exemplary embodiment of the present disclosure.

FIG. 5 is a diagram illustrating content displayed in a virtual space according to an exemplary embodiment of the present disclosure.

FIG. 6 is a diagram illustrating an example in which rendering cameras are arranged in a virtual space according to an exemplary embodiment of the present disclosure.

FIG. 7 is a diagram illustrating a final displayed image resulted from a rendering operation performed in FIG. 6 according to an exemplary embodiment of the present disclosure.

FIG. 8 is a diagram illustrating an example of a rendering operation in the case where a display device is rotated according to an exemplary embodiment of the present disclosure.

FIG. 9 is a diagram illustrating an example in which content in a normal position is displayed in a display device by camera rotation shown in FIG. 8 according to an exemplary embodiment of the present disclosure.

FIG. 10 is a flowchart illustrating a multi-display controlling method according to an exemplary embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

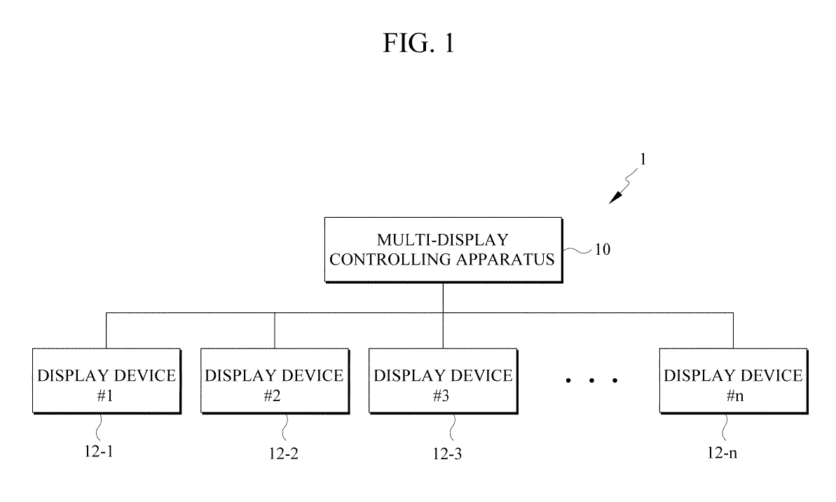

FIG. 1 is a diagram illustrating a configuration of a multi-display system according to an exemplary embodiment of the present disclosure.

Referring to FIG. 1, a multi-display system 1 includes a multi-display controlling apparatus 10, and multiple display devices 12-1, 12-2, 12-3, . . . , and 12-N.

The multi-display controlling apparatus 10 manages and controls the display devices 12-1, 12-2, 12-3, . . . , and 12-N. The multi-display controlling apparatus 10 receives space information of the display devices 12-1, 12-2, 12-3, . . . , and 12-N, and creates a virtual space to display content. The space information indicates information about a physical space where the display devices 12-1, 12-2, 12-3, . . . , and 12-N are located in a physical word. For example, the space information includes location information, size information, and rotation information on a of each of the display devices 12-1, 12-2, 12-3, . . . , and 12-N, and information on relationships between the display devices 12-1, 12-2, 12-3, . . . , and 12-N.

The multi-display controlling apparatus 10 generates a scene by mapping contents to a location of each of the display devices 12-1, 12-2, 12-3, . . . , and 12-N in a virtual space based on the space information of each of the display devices 12-1, 12-2, 12-3, . . . , and 12-N. In addition, the multi-display controlling apparatus 10 transmits scene information to a corresponding display device among the display devices 12-1, 12-2, 12-3, . . . , and 12-N. As physical space information of each of the display devices 12-1, 12-2, 12-3, . . . , and 12-N are reflected to the content, thereby providing a sense of reality and immersion to an observer.

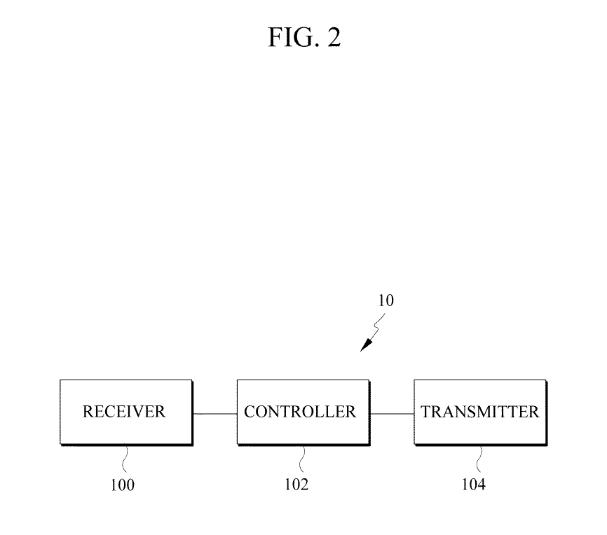

Specifically, space information of each of the display devices 12-1, 12-2, 12-3, . . . , and 12-N is changed in real time, and the multi-display controlling apparatus 10 controls each of the display devices 12-1, 12-2, 12-3, . . . , and 12-N by reflecting the space information of each of the display devices 12-1, 12-2, 12-3, . . . , and 12-N. Accordingly, the space information can be reflected in content in real time even in the case where the display devices 12-1, 12-2, 12-3, . . . , and 12-N are dynamically changed. Detailed configuration of the multi-display controlling apparatus 10 is described in conjunction with FIG. 2.

The display devices 12-1,12-2,12-3, . . . , and 12-N are devices having a screen to display an image, and installed indoor or outdoor. The display devices 12-1,12-2,12-3, . . . , and 12-N may be a large-sized device. For example, the display devices 12-1,12-2,12-3, . . . , and 12-N may be a digital signage or a digital bulletin board installed in a public space, but aspects of the present disclosure are not limited thereto. Each of the display devices 12-1, 12-2, 12-3, . . . , and 12-N receives, from the display controller 10, image information where space information of each of the display devices 12-1, 12-2, 12-3, . . . , and 12-N is reflected, and displays the received image information.

FIG. 2 is a diagram illustrating a detailed configuration of the multi-display controlling apparatus shown in FIG. 1 according to an exemplary embodiment of the present disclosure.

Referring to FIG. 2, the multi-display controlling apparatus 10 includes a receiver 100, a controller 102, and a transmitter 104.

The receiver 100 receives space information of each display device. The receiver 100 receives space information of each display device from a sensor. The sensor may be formed in each display device or may be formed in an external device.

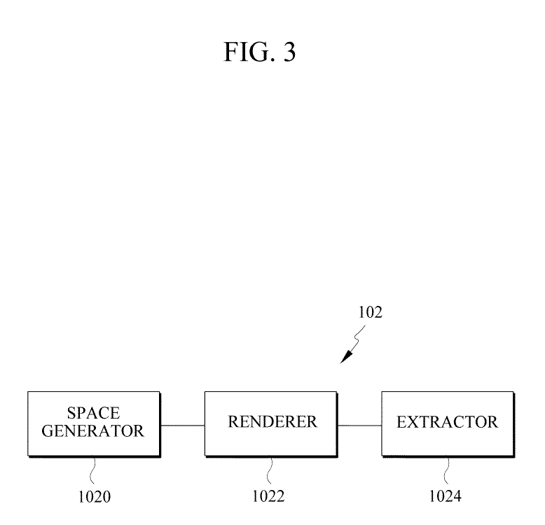

The controller 102 generates a virtual space and then generates a scene by mapping content to a screen of each display device in the generated virtual space based on space information of the corresponding display device. Specifically, the controller 102 maps content to a screen of each display device by reflecting in real time space information of the corresponding display device that is dynamically changed. A detailed configuration of the controller 102 is described in conjunction with FIG. 3.

The transmitter 104 provides scene information, which is information on a scene generated in the controller 102, to the display devices. For example, the transmitter 104 transmits the scene information to the display devices over a wired/wireless network. In another example, the transmitter 104 transmits the scene information through a communication device. According to an exemplary embodiment of the present disclosure, the transmitter 104 compresses the scene information and transmits the compressed information to the display devices.

FIG. 3 is a diagram illustrating a detailed configuration of the controller shown in FIG. 2 according to an exemplary embodiment of the present disclosure.

Referring to FIG. 3, the controller 102 includes a space generator 1020, a renderer 1022, and an extractor 1024.

The space generator 1020 generates a 3D virtual space, inputs content in the generated virtual space, and determines a location and angle of each display device based on space information thereof. The renderer 1022 generates a scene by mapping the content to a screen of each display device based on the corresponding display device's location and angle determined by the space generator 1020. The extractor 1024 extracts a rendering result that is mapped to a screen of each display device.

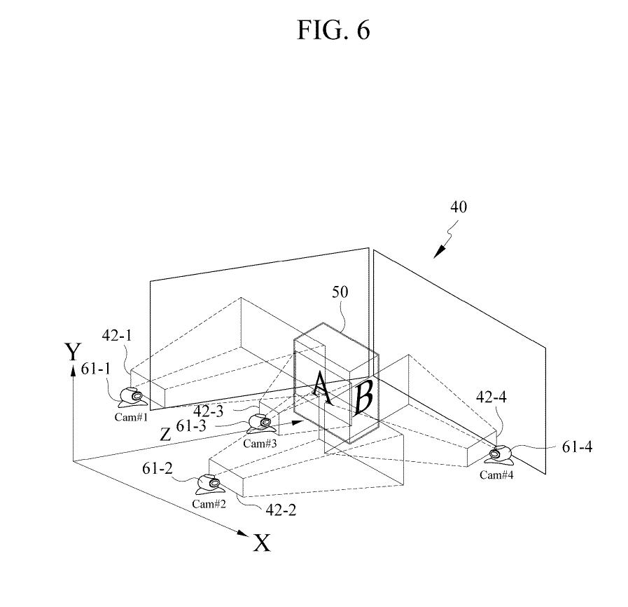

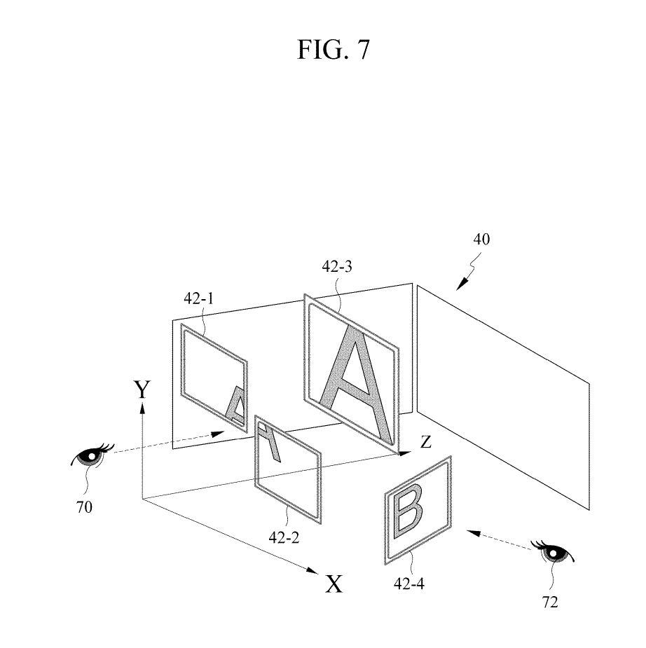

The renderer 1022 arranges cameras at locations of display devices based on space information of each of the display devices and maps content displayed on a screen of each display device into a real physical space. At this point, the renderer 1022 may arrange the cameras based on location information of each of the display devices and enlarge or reduce content displayed on a specific screen. Embodiments of arrangement of cameras are described in conjunction with FIGS. 6 and 7. In another example, the renderer 1022 may rotate a specific camera based on rotation information of a display device corresponding to the specific camera in order to offset rotation of a rotated screen of the corresponding display device.

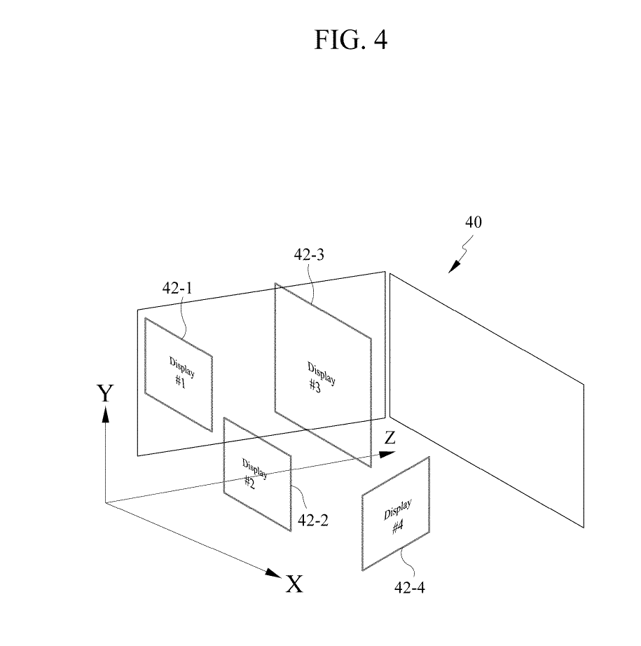

FIG. 4 is a conceptual diagram illustrating a virtual space according to an exemplary embodiment of the present disclosure.

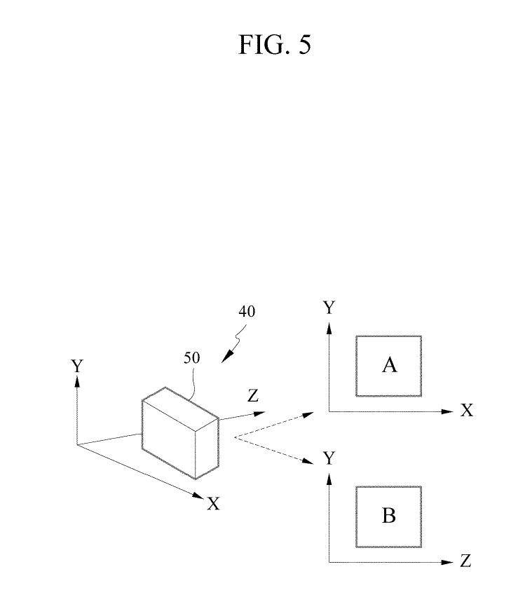

Referring to FIG. 4, a virtual space 40 is a space in which screens 42-1, 42-2, 42-3, and 42-4 of display devices are expanded in 3D. FIG. 4 illustrates the screens 42-1, 42-2, 42-3, and 42-4 of the four display devices, but it is merely exemplary for convenience of explanation and aspects of the present disclosure are not limited thereto. Virtual content, for example, a 3D object, is displayed in the virtual space 40. Examples of the virtual content are described in conjunction with FIG. 5.

FIG. 5 is a diagram illustrating content displayed in a virtual space according to an exemplary embodiment of the present disclosure.

Referring to FIG. 5, virtual content 50 may be displayed in a virtual space 40. The content 50 may be a 3D object, as illustrated in FIG. 5. To provide more understanding, suppose that specific facets of the object 50 has characters A and B, respectively. For example, A is formed in an XY-plane and B is formed in an YZ-plane. However, it is merely exemplary and aspects of the present disclosure are not limited thereto.

FIG. 6 is a diagram illustrating an example in which rendering cameras are arranged in a virtual space according to an exemplary embodiment of the present disclosure.

Referring to FIG. 6, rendering cameras 61-1, 61-2, 61-3, and 61-4 are arranged at locations of screens 42-1, 42-2, 42-3, and 42-4, respectively, and content displayed on the screen 42-1, 42-2, 42-3, and 42-4 are mapped into a 3D physical space. For example, as illustrated in FIG. 6, camera #1 61-1 and camera #2 61-2 are arranged at locations of screen #1 42-1 and screen #2 42-2, respectively.

A multi-display controlling apparatus according to an exemplary embodiment reflects properties of a real physical space in the virtual space 40 based on space information of the display devices. At this point, the multi-display controlling apparatus may be informed of depth information of the display devices, and thus, arrange cameras at location of the screens based on depth information of corresponding display devices and adjust size of content displayed on each of the screens. For example, as illustrated in FIG. 6, the multi-display controlling apparatus moves camera #3 61-3 closer to the content 50 based on depth information of display device #3. At this point, if an observer sees screen #3 42-3 in the direction of the Z axis, the multi-display controlling apparatus controls content displayed on screen #3 42-3 to be enlarged in the virtual space 40.

If depth information of a display device is not considered, camera #3 61-3 may display an image of same size as that of camera #1 61-1 and camera #2 61-2. In this case, it is not possible to reflect the real distance between the content and the display device. However, the present disclosure maps enlarged content to screen #3 42-3 in the virtual space 40 based on space information of the display devices, and thus, an organic combination of display devices helps display content in which a real environment is reflected.

Meanwhile, as illustrated in FIG. 6, camera #4 61-4 captures a side facet of the content 50. If this property is used when the present disclosure is applied to a wall, an observer is able to see even a facet of the content 50 which is not located within a field of vision of the observer. Thus, the observer is able to recognize a real 3D space.

FIG. 7 is a diagram illustrating a final displayed image resulted from a rendering operation performed in FIG. 6 according to an exemplary embodiment of the present disclosure.

Referring to FIG. 7, content whose properties are reflected is displayed on screens 42-1, 42-2, 42-3, and 42-4 of display devices based on space information of each of the display devices.

For example, content is displayed separately on screen #1 42-1 and screen #2 42-2, both of which are at the same distance from observer A 70, enlarged content is displayed on screen #3 42-3 further distant from observer A 70, and content is displayed on a location at which observer B 72 is able to see. As described above, the virtual space 40 is generated using space information that is about a real physical space where each display device is located, and content is displayed by reflecting the space information. In this manner, the present disclosure may provide a noble standard for displaying content.

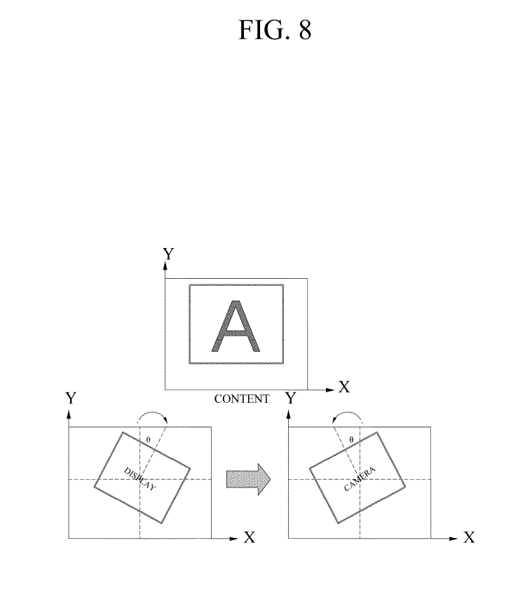

FIG. 8 is a diagram illustrating an example of a rendering operation in the case where a display device is rotated according to an exemplary embodiment of the present disclosure.

Referring to FIG. 8, when a display device is rotated in a real physical space, an observer performs rendering to see content regardless of the rotation. If a rotation angle of a display device is θ, as shown in the example of FIG. 8, a multi-display controlling apparatus according to an exemplary embodiment sets a rotational angle of a rendering camera as −θ in order to offset the rotation of a display device corresponding to the camera.

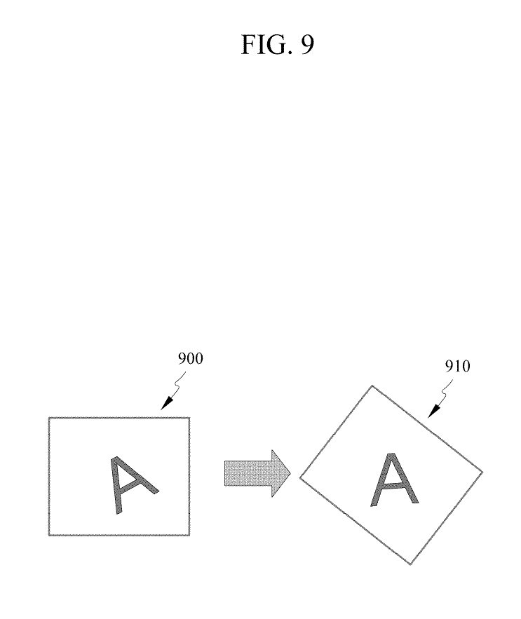

FIG. 9 is a diagram illustrating an example in which content in a normal position is displayed in a display device through rotation of a camera, which is shown in FIG. 8, according to an exemplary embodiment of the present disclosure.

Referring to FIG. 9, in the case where content is extracted by rotating a camera, a rotated character is displayed on a screen of a display device that is not rotated in a physical space, as shown in the left side 900 of FIG. 9. However, according to the present disclosure, if a screen of a display device is rotated at θ, a character in a normal position is displayed, as shown in the right side 910 of FIG. 9.

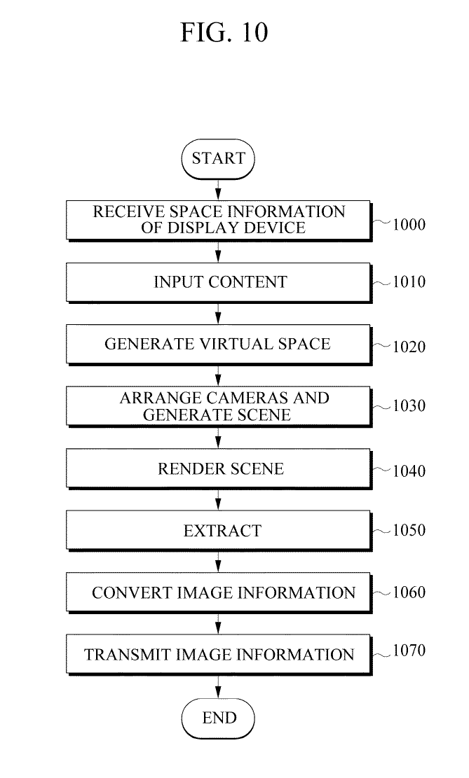

FIG. 10 is a flowchart illustrating a multi-display controlling method according to an exemplary embodiment of the present disclosure.

Referring to FIG. 10, a multi-display controlling apparatus receives space information of multiple display devices in 1000. The space information includes location information, size information, and rotation information of each of the multiple display devices.

Then, the multi-display controlling apparatus inputs content based on the space information in 1010, and generates a virtual space in 1020. Then, the multi-display controlling apparatus generates a scene by mapping content based on a relationship with a physical space by means of cameras. For example, the multi-display controlling apparatus generates a scene by arranging cameras at locations of screens of display devices according to space information of each of the display devices and mapping content to each of the screens.

Then, the multi-display controlling apparatus renders the scene in 1040, and extracts a result mapped to the screen in 1050. At this point, the multi-display controlling apparatus may convert image information in 1060. The conversion may include image compression, video compression, or information compression.

Then, the multi-display controlling apparatus transmits the image information to the display devices through a network or a specific communication device in 1070. Then, the display devices may display the received image information.

In the case where compressed content is transmitted, a display device receives image information using a small USB set-top box in a wired or wireless manner and displays the received image information. Accordingly, it does not need to concern size of a space too much when installing the multi-display controlling apparatus, and it is easy to install and manage a system for multiple display devices, and thus, the present disclosure may take advantage of great utility.

According to an exemplary embodiment, the present disclosure provides content to multiple display devices by reflecting space information that is about a real physical space where the display devices are located, so that an observer may feel a sense of reality and immersion. In particular, contents are provided by reflecting the display devices' space information that is changed in real time, so that the space information can be reflected in the content in real time even in the case where the display devices are dynamically changed. In this case, the present disclosure may provide the content which is automatically enlarged or reduced based on location information or rotated based on rotation information of the display devices.

Furthermore, content is transmitted to the display devices through a communication device, such as a small USB set-top box, in a wired or wireless manner. Accordingly, it does not need to concern size of a space too much when installing the multi-display controlling apparatus, and it is easy to install and manage a system for multiple display devices, and thus, the present disclosure may take advantage of great utility. The present disclosure may spur the generation of content based on space perception, and it will be used as the most effective means for exhibition, advertisement, and information delivery.

A number of examples have been described above. Nevertheless, it should be understood that various modifications may be made. For example, suitable results may be achieved if the described techniques are performed in a different order and/or if components in a described system, architecture, device, or circuit are combined in a different manner and/or is replaced or supplemented by other components or their equivalents. Accordingly, other implementations are within the scope of the following claims.

What is claimed is:

1. A multi-display controlling apparatus comprising:
a receiver configured to receive space information of multiple display devices;
a controller configured to generate a virtual space and generates a scene by mapping content to a screen of each of the multiple display devices in the virtual space based on the space information; and
a transmitter configured to transmit information on the generated scene to each of the multiple display devices.

2. The multi-display controlling apparatus of claim 1, wherein the space information comprises location information, size information, and rotation information of each of the multiple display devices.

3. The multi-display controlling apparatus of claim 1, wherein the receiver receives the space information of each of the multiple display devices from a sensor.

4. The multi-display controlling apparatus of claim 1, wherein the controller maps the content to a screen of each of the multiple display devices based on real-time space information of each of the multiple display devices that are dynamically changed.

5. The multi-display controlling apparatus of claim 1, wherein the controller comprises:
a space generator configured to generate the virtual space, arrange the content in the virtual space, and determine a location and angle of each of the multiple display devices based on the space information;
a renderer configured to generate the scene by mapping the content to a screen of each of the multiple display devices based on the determined location and angle, and render the scene; and
an extractor configured to extract a rendering result that is mapped to a screen of each of the multiple display devices.

6. The multi-display controlling apparatus of claim 5, wherein the renderer arranges cameras at locations of the multiple display devices based on the space information and maps content displayed on a screen of each of the multiple display devices into a real physical space.

7. The multi-display controlling apparatus of claim 6, wherein the renderer arranges the cameras based on the location information of each of the display devices and enlarges or reduces the content displayed on a screen of a corresponding display device.

8. The multi-display controlling apparatus of claim 6, wherein the renderer rotates a specific camera based on rotation information of a corresponding display devices in order to offset rotation of a screen of the corresponding display device.

9. The multi-display controlling apparatus of claim 1, wherein the content is three-dimensional (3D) content to be displayed in a virtual space.

10. The multi-display controlling apparatus of claim 1, wherein the transmitter transmits the content to each of the multiple display devices over a wired or wireless network.

11. The multi-display controlling apparatus of claim 1, wherein the transmitter transmits image information through a communication device included in each of the multiple display devices.

12. The multi-display controlling apparatus of claim 1, wherein the transmitter compresses image information and transmits the compressed image information to each of the multiple display devices.

13. A multi-display controlling method comprising:
receiving space information of multiple display devices;
is generating a virtual space and generating a scene by mapping content to a screen of each of the multiple display devices in the virtual space based on the space information; and
transmitting information on the scene to each of the multiple display devices.

14. The multi-display controlling method of claim 13, wherein the space information comprises location information, size information, and rotation information of each of the multiple display devices.

15. The multi-display controlling method of claim 13, wherein the generating of a scene comprises generating the scene by mapping the content to each of the multiple display devices based on real-time space information of each of the multiple display devices that are changed dynamically.

16. The multi-display controlling method of claim 13, wherein the generating of a scene comprises:
generating the virtual space, arranging the content in the virtual space, and determining a location and angle of each of the multiple display devices based on the space information;
generating a scene by mapping the content to a screen of each of the multiple display devices based on the determined location and angle, and rendering the scene; and
extracting a rendering result mapped to the screen of each of the multiple display devices.

17. The multi-display controlling method of claim 16, the rendering of a scene comprises arranging cameras at locations of the multiple display devices based on the space information and mapping content displayed on a screen of each of the display devices into a real physical space.

18. The multi-display controlling method of claim 16, wherein the rendering of the scene comprises arranging the cameras based on location information of each of the multiple display devices and enlarging or reducing the content displayed on a screen of a corresponding screen.

19. The multi-display controlling method of claim 16, the rendering of the scene comprises rotating a specific camera based on location information of a corresponding display device to offset rotation of a screen of the corresponding display device.
